(19) United States
(12) Patent Application Publication
(10) Pub. No.: US 2008/0055196 A1
(43) Pub. Date: Mar. 6, 2008

(54) Light emitting element driver and light emitting element driving method

(75) Inventor: Eiji Izumida, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/892,772

(22) Filed: Aug. 27, 2007

(30) Foreign Application Priority Data
Aug. 30, 2006 (JP) 2006-233556

(51) Int. Cl. G09G 3/14

(52) U.S. Cl. 345/46

(57) ABSTRACT

In a high luminance area having a target luminance L of not lower than a preset reference luminance L0, the light emitting element driver of the invention adopts a direct current drive mode and enables the function of a constant current driving circuit to drive an LED or light emitting diode. In a low luminance area having the target luminance L of lower than the preset reference luminance L0, on the other hand, the light emitting element driver adopts a pulse width modulation drive mode and enables the function of a pulse width modulation driving circuit to drive the LED. This control procedure enables the luminance adjustment by the pulse width modulation drive control in the low luminance area, while ensuring the high power efficiency by the direct current drive control in the high luminance area. The advantage of this arrangement simultaneously satisfies both the luminance adjustment in a wide range including the low luminance area and the high power efficiency.

### CROSS REFERENCE TO RELATED APPLICATIONS

The present application claims the priority based on Japanese Patent Application No. 2006-233556 filed on Aug. 30, 2006, the disclosure of which is hereby incorporated by reference in its entirety.

### BACKGROUND OF THE INVENTION

1. Field of the Invention

The present invention relates to a light emitting element driver to adjust the luminance of a light emitting element to a target luminance and to a corresponding light emitting element driving method.

2. Description of the Related Art

High-luminance LEDs have drawn attention as prospective one of light emitting elements. The luminance of an LED is adjustable by varying the value of forward current. FIG. 5 is a graph showing a variation in relative luminosity of a conventional LED against forward current If. The relative luminosity is plotted against the forward current If with the luminosity at the forward current If of 2 [A] set to ‘1’. As clearly seen in this graph, varying the value of the forward current If adjusts the luminosity or the luminance of the LED.

There are two different drive modes for luminance adjustment of the LED, that is, direct current drive control and pulse width modulation drive control. The direct current drive control directly varies the current value. The pulse width modulation drive control does not vary the current value but varies the ratio of the on time to the off time of the pulse (duty ratio) to regulate the current flow time (see, for example, JP 2006-49423A).

A forward voltage at the minimum is required for emission of the LED. The LED has substantially no electric current at voltages of lower than the forward voltage but an abrupt flow of electric current at voltages of or over the forward voltage. The direct current drive control accordingly has difficulty in luminance adjustment in a low luminance area of lower than the forward voltage.

The pulse width modulation drive control regulates the duty ratio of the pulse and readily attains the luminance adjustment in a whole luminance range including the low luminance area. The pulse width modulation drive control, however, has a disadvantage of significantly low power efficiency, compared with the direct current drive control.

A one-dot chain line curve in the graph of FIG. 5 shows a variation in power efficiency. The power efficiency is plotted against the forward current If with the power efficiency at the forward current If of 2 [A] to 100%. As clearly seen in this graph, the power efficiency decreases with an increase in value of the forward current If. The relative luminosity is 3 at the forward current If of 8 [A]. This value is less than a 4-fold increase from the relative luminance of ‘1’ in the direct current drive at the forward current If of 2 [A]. This proves the decrease in power efficiency with an increase in value of the forward current If. The pulse width modulation drive control uses the high forward current If to regulate the duty ratio of the pulse for the luminance adjustment as mentioned above. The power efficiency in the pulse width modulation of the forward current If of 8 [A] at a duty ratio of 25% (equivalent to the direct current drive at the forward current If of 2 [A]) is significantly lower than the power efficiency in the direct current drive at the forward current If of 2[A].

### SUMMARY

An advantage of some aspects of the invention is to satisfy both luminance adjustment in a wide range including a low luminance area and high power efficiency.

According to a first aspect of the invention, there is provided to a light emitting element driver. The light emitting element driver adjusts luminance of a light emitting element to a target luminance. The light emitting element driver includes: a constant current driving circuit that receives a current value specification signal and supplies a current signal having a current value specified by the current value specification signal as a driving signal to the light emitting element; a pulse width modulation driving circuit that receives a pulse width specification signal for specifying a duty ratio of a pulse and supplies a current signal having a pulse width modulated by the pulse width specification signal as a driving signal to the light emitting element; a luminance detector that identifies whether the target luminance is in a low luminance area or in a high luminance area; a high luminance controller that, upon identification of the target luminance in the high luminance area by the luminance detector, outputs a current value specification signal corresponding to the target luminance to the constant current driving circuit and changes over the driving signal supplied to the light emitting element to an output of the constant current driving circuit; and a low luminance controller that, upon identification of the target luminance in the low luminance area by the luminance detector, outputs a pulse width specification signal corresponding to the target luminance to the pulse width modulation driving circuit and changes over the driving signal supplied to the light emitting element to an output of the pulse width modulation driving circuit.

Upon identification of the target luminance in the high luminance area by the luminance detector, the light emitting element driver of the first aspect of the invention enables the function of the constant current driving circuit to drive the light emitting element. Upon identification of the target luminance in the low luminance area by the luminance detector, on the other hand, the light emitting element driver enables the function of the pulse width modulation driving circuit to drive the light emitting element. This control procedure enables the luminance adjustment by the pulse width modulation driving circuit in the low luminance area, while ensuring the high power efficiency by the constant current driving circuit in the high luminance area. The advantage of this arrangement simultaneously satisfies both the luminance adjustment in a wide range including the low luminance area and the high power efficiency.

According to a second aspect of the invention, there is provided to a light emitting element driving method. The light emitting element driving method adjusts luminance of a light emitting element to a target luminance. The light emitting element driving method identifies whether the target luminance is in a low luminance area or in a high luminance area. Upon identification of the target luminance in the high luminance area, the light emitting element driving method supplies a current signal having a current value corresponding to the target luminance as a driving signal to the light emitting element. Upon identification of the target luminance in the low luminance area, the light emitting element driving method supplies a current signal having a pulse width modulated corresponding to the target luminance as a driving signal to the light emitting element.

The advantage of the light emitting element driving method of the second aspect of the invention simultaneously satisfies both the luminance adjustment in the wide range including the low luminance area and the high power efficiency, similarly to the advantage of the light emitting element driver described above.

### BRIEF DESCRIPTION OF THE DRAWINGS

FIG. 1 is a block diagram schematically illustrating the structure of a light emitting element driver in one embodiment of the invention;

FIG. 2 is a flowchart showing a luminance control routine executed by a controller included in the light emitting element driver of the embodiment;

FIG. 3 is a graph showing a luminance characteristic curve of an LED against forward current If;

FIG. 4 is a graph showing a variation in light emission luminance of the LED against a current signal I2 output from a constant current driving circuit included in the light emitting element driver of the embodiment; and

FIG. 5 is a graph showing a variation in relative luminosity of a conventional LED against forward current If.

### DESCRIPTION OF THE PREFERRED EMBODIMENTS

One mode of carrying out the invention is described below as a preferred embodiment with reference to the accompanied drawings:

A. Structure

B. Functions and Effects

C. Modifications

A. Structure

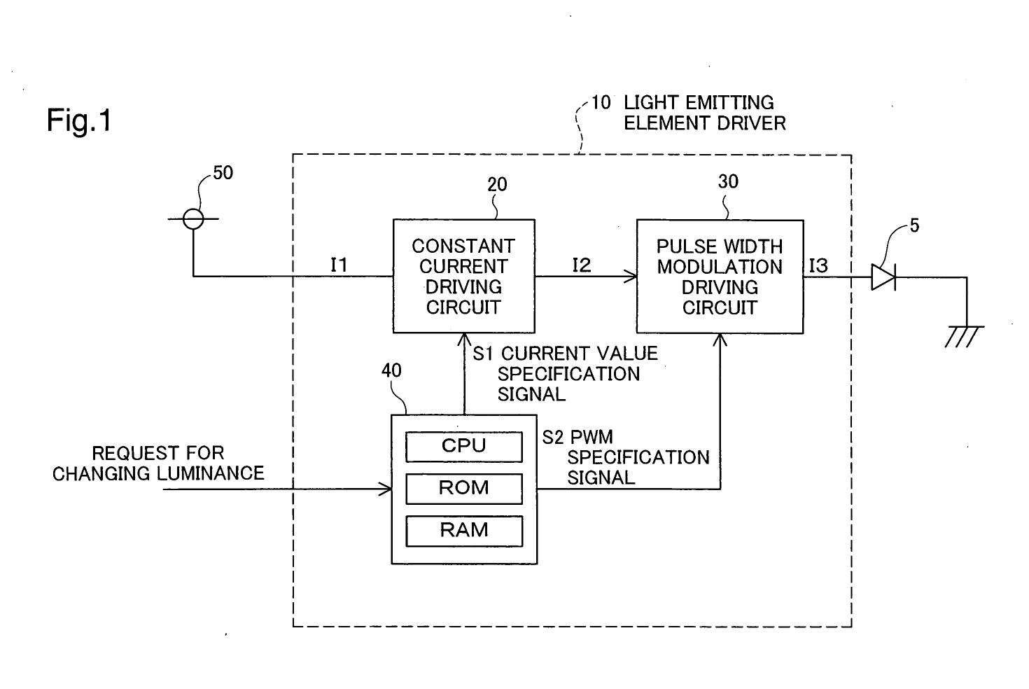

FIG. 1 is a block diagram schematically illustrating the structure of a light emitting element driver 10 in one embodiment of the invention. An image display device, such as a projector, has multiple light emitting diodes (LEDs) arranged in an array. In the structure of FIG. 1, the light emitting element driver 10 is connected to an LED 5 as one of the multiple LEDs in the image display device.

The light emitting element driver 10 has a constant current driving circuit 20, a pulse width modulation driving circuit 30, and a controller 40. The constant current driving circuit 20 is linked to a power source 50 and has an output connecting with the pulse width modulation driving circuit 30. An output of the pulse width modulation driving circuit 30 is transmitted as a driving signal to the LED 5.

The constant current driving circuit 20 externally receives a current value specification signal for specifying a current value and outputs a current signal representing the current value specified by the current value specification signal. In the illustrated structure of FIG. 1, the constant current driving circuit 20 receives a current value specification signal S1 from the controller 40 and a current signal I1 from the power source 50, converts the received current signal I1 into a current signal I2 having a current value specified by the current value specification signal S1, and outputs the converted current signal I2 to the pulse width modulation driving circuit 30. The detailed circuit structure of the constant current driving circuit 20 is known in the art and is thus not specifically described here.

The pulse width modulation driving circuit 30 generates a signal of variable pulse width. The on-off time ratio of the pulse per unit time (duty ratio) is determined by an externally received PWM (pulse width modulation) specification signal. In the illustrated structure of FIG. 1, the pulse width modulation driving circuit 30 receives a PWM specification signal S2 from the controller 40 and the current signal I2 output from the constant current driving circuit 20, converts the received current signal I2 into a current signal I3 as a pulse signal having the duty ratio specified by the PWM specification signal S2, and outputs the converted current signal I3 to the LED 5. The detailed circuit structure of the pulse width modulation driving circuit 30 is known in the art and is thus not specifically described here.

The controller 40 is constructed by a known microcomputer including a CPU, a ROM, and a RAM. The ROM stores in advance a computer program for luminance control to change the luminance of the LED 5. The CPU executes the computer program with using the RAM as a working area. The functions attained by the software configuration in the structure of the embodiment may alternatively be actualized by the hardware configuration.

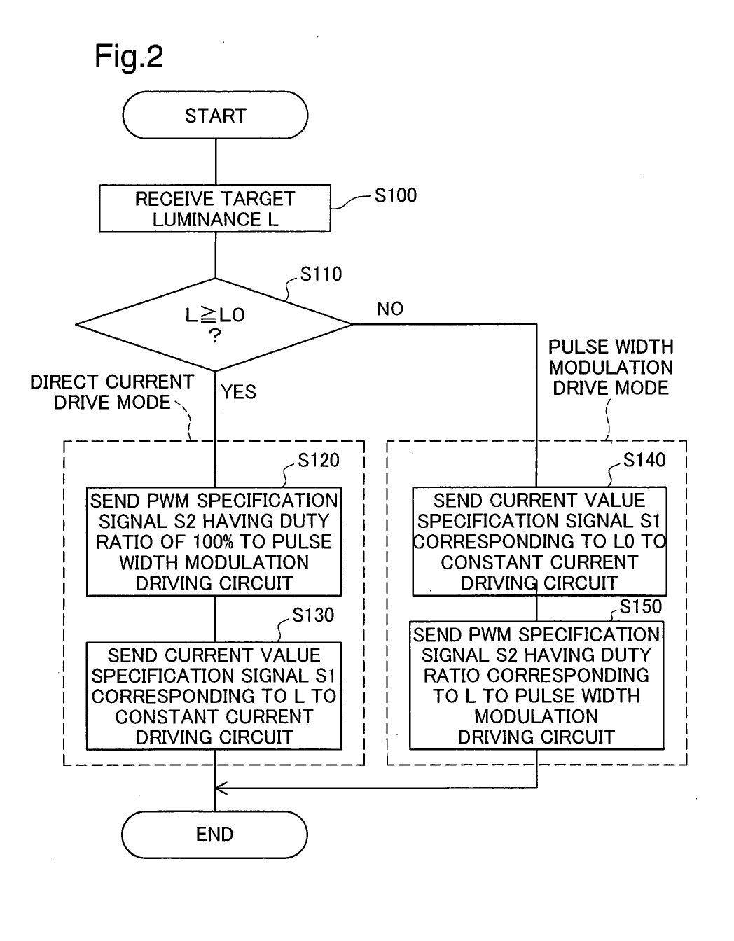

FIG. 2 is a flowchart showing a luminance control routine executed by the controller 40. The luminance control routine is based on the computer program and is triggered by the internal CPU of the controller 40 in response to an external request for changing the luminance of the LED 5. In the luminance control routine, the CPU first externally receives a target luminance L as an object specified by the external request for changing the luminance of the LED 5 (step S100).

The CPU subsequently determines whether the received target luminance L is not lower than a preset reference luminance L0 (step S110). The reference luminance L0 is based on forward voltage of the LED 5 and is individually set for each LED 5. A forward voltage is specified according to the product standard of each LED, and the reference luminance L0 represents a light emission luminance in forward current flowing at the forward voltage. The preset reference luminance L0 is stored in advance in the ROM and is read out according to the requirements.

Upon determination at step S110 that the target luminance L is not lower than the preset reference luminance L0, that is, in a high luminance area, the CPU adopts a direct current drive mode to enable the function of the constant current driving circuit 20. Upon determination at step S110 that the target luminance L is lower than the preset reference luminance L0, that is, in a low luminance area, on the other hand, the CPU adopts a pulse width modulation drive mode to enable the function of the pulse width modulation driving circuit 30.

The direct current drive mode is equivalent to the function of the ‘high luminance controller’ of the invention and has steps S120 and S130. Upon determination of L≧L0 at step S110, the CPU sends the PWM specification signal S2 having the duty ratio (that is, the time ratio of level ‘H’ in one period) of 100% to the pulse width modulation driving circuit 30 (step S120) and sends the current value specification signal S1 corresponding to the target luminance L to the constant current driving circuit 20 (step S130).

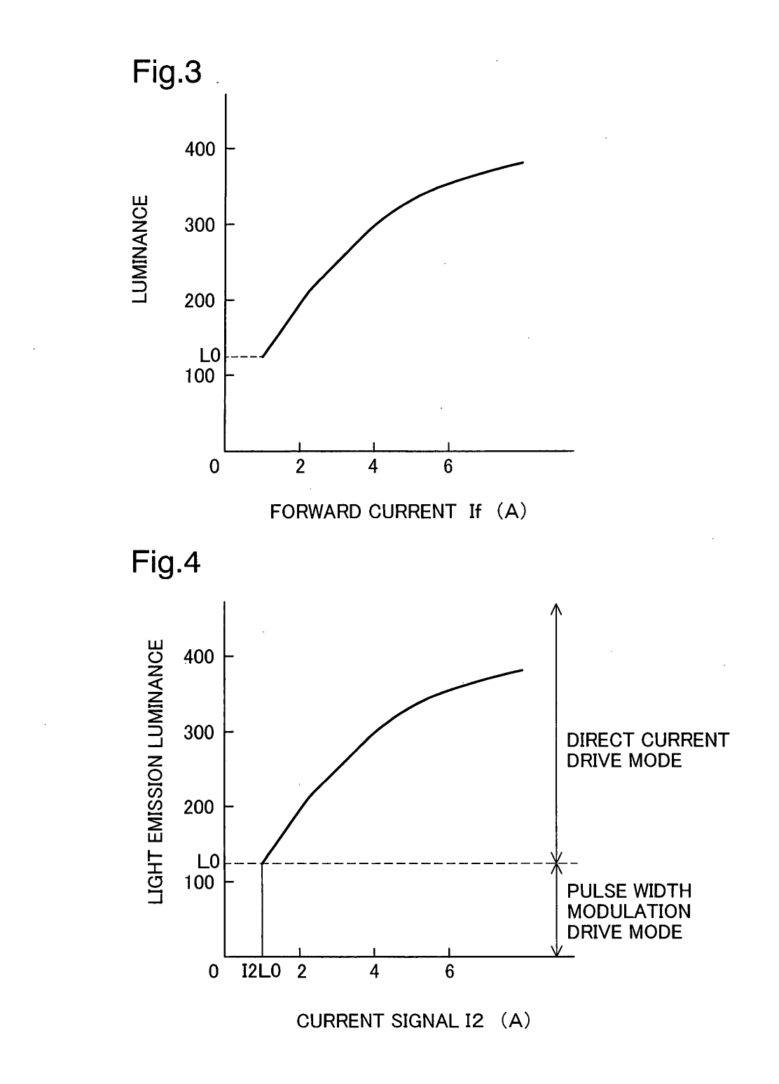

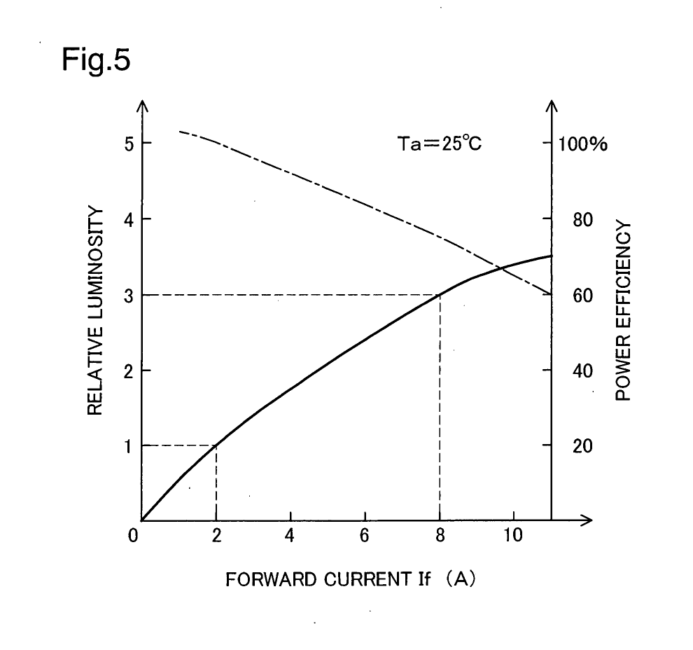

FIG. 3 is a graph showing a luminance characteristic curve of the LED 5 against forward current If. Two-dimensional map data representing the graph is stored in advance in the ROM of the controller 40. At step S130, the CPU refers to the two-dimensional map data, reads a current value of the forward current If corresponding to the target luminance L, and sends the current value specification signal S1 representing the read current value. This luminance characteristic curve of FIG. 3 corresponds to the variation in relative luminosity against the forward current If shown in the graph of FIG. 5.

The pulse width modulation driving circuit 30 receives the PWM specification signal S2 having the duty ratio of 100% and thereby transmits an input signal as an output driving signal without any conversion. The driving signal output to the LED 5 is accordingly the current signal I2 representing the current value corresponding to the target luminance L. The direct current drive mode changes the luminance of the LED 5 in this manner.

The pulse width modulation drive mode is equivalent to the function of the ‘low luminance controller’ of the invention and has steps S140 and S150. Upon determination of L<L0 at step S110, the CPU sends the current value specification signal S1 corresponding to the preset reference luminance L0 to the constant current driving circuit 20 (step S140) and sends the PWM specification signal S2 having a duty ratio corresponding to the target luminance L to the pulse width modulation driving circuit 30 (step S150).

The preset reference luminance L0 is stored in advance in the ROM as mentioned previously and defines a luminance threshold on the boundary between the direct current drive mode and the pulse width modulation drive mode. At step S140, the CPU sends the current value specification signal S1 representing a current value corresponding to the preset reference luminance L0 as a minimum luminance in an allowable luminance control range by the direct current drive control of steps S120 and S130. This current value is hereafter referred to as forward voltage-current value. The constant current driving circuit 20 receives the current value specification signal S1 and outputs the current signal I2 representing the forward voltage-current value specified by the current value specification signal S1.

The pulse width modulation driving circuit 30 receives the PWM specification signal S2 having the duty ratio corresponding to the target luminance L at step S150 and performs pulse width modulation of the current signal I2, which represents the forward voltage-current value and is sent from the constant current driving circuit 20, based on the PWM specification signal S2. The output of the pulse width modulation driving circuit 30 is transmitted as a driving signal to the LED 5. The pulse width modulation drive mode changes the luminance of the LED 5 in this manner.

The CPU terminates the luminance control routine on completion of either the direct current drive control or the pulse width modulation drive control, that is, after the processing of step S130 or the processing of step S150.

B. Functions and Effects

In the high luminance area having the target luminance L of not lower than the preset reference luminance L0, the light emitting element driver 10 of the embodiment adopts the direct current drive mode and enables the function of the constant current driving circuit 20 to drive the LED 5. In the low luminance area having the target luminance L of lower than the preset reference luminance L0, on the other hand, the light emitting element driver 10 adopts the pulse width modulation drive mode and enables the function of the pulse width modulation driving circuit 30 to drive the LED 5. The control procedure of the embodiment enables the luminance adjustment by the pulse width modulation drive control in the low luminance area, while ensuring the high power efficiency by the direct current drive control in the high luminance area. The advantage of this arrangement simultaneously satisfies both the luminance adjustment in a wide range including the low luminance area and the high power efficiency.

FIG. 4 is a graph showing a variation in light emission luminance of the LED 5 against the current signal I2 output from the constant current driving circuit 20. As clearly shown in the graph of FIG. 4, in the low luminance area where the light emission luminance of the LED 5 is lower than the preset reference luminance L0, the current signal 12 keeps a forward voltage-current value I2L0 corresponding to the preset reference luminance L0. The current signal I2 having the forward voltage-current value I2L0 is subjected to the pulse width modulation drive control. The pulse width modulation drive control regulates the duty ratio or the current flow time without varying the current value. Although the current signal as the object of the pulse width modulation drive control may have a higher base current value than the forward voltage-current value I2L0, the current signal I2 of this embodiment has the forward voltage-current value I2L0 as the base current value. Namely the pulse width modulation drive control by the pulse width modulation driving circuit 30 uses the current signal I2 having a current value of the highest power efficiency in the allowable luminance control range by the constant current driving circuit 20. This desirably improves the power efficiency in the low luminance area.

In the structure of the embodiment, the pulse width modulation driving circuit 30 is provided on the pathway from the constant current driving circuit 20 to the LED 5 and accordingly does not require any separate power source. This arrangement desirably simplifies the structure of the light emitting element driver 10.

C. Modifications

The embodiment discussed above is to be considered in all aspects as illustrative and not restrictive. There may be many modifications, changes, and alterations without departing from the scope or spirit of the main characteristics of the present invention.

(1) The control procedure of the embodiment identifies the high luminance area and the low luminance area, based on the determination of whether the target luminance L is not lower than the preset reference luminance L0. One possible modification may store in advance the forward voltage-current value I2L0 in the ROM, specify a current value corresponding to the target luminance L, and determine whether the specified current value is not lower than the forward voltage-current value 12L0. Another possible modification may specify a current value corresponding to the target luminance L, calculate a voltage corresponding to the specified current value, and determine whether the calculated voltage is not lower than the forward voltage.

(2) The control procedure of the embodiment uses the forward voltage as the criterion for identifying the high luminance area and the low luminance area. The criterion for such identification is not restricted to the forward voltage. The direct current drive control has difficulty in luminance adjustment in a specific area where the luminance is not linearly proportional to the forward current. As long as this specific area is identifiable, the criterion may be set higher than or lower than the forward voltage.

(3) The control procedure of the embodiment identifies the high luminance area and the low luminance area, based on the determination of whether the target luminance L is not lower than the preset reference luminance L0. In one modified structure, the constant current driving circuit 20 is designed to notify the controller 40 of the output current value. The controller 40 first enables the function of the constant current driving circuit 20 to perform the direct current drive control according to the target luminance L. When the current value notified by the constant current driving circuit 20 decreases below the forward voltage-current value I2L0, the controller 40 enables the function of the pulse width modulation driving circuit 30. This modified structure exerts the similar effects to those of the embodiment described above. The direct comparison with the target luminance L is not essential for identification of the target luminance L in the high luminance area or in the low luminance area. Any other suitable parameter having a linear relation to the target luminance L may be used for such comparison.

(4) In the light emitting element driver 10 of the embodiment, the pulse width modulation driving circuit 30 is provided on the pathway of the current signal from the constant current driving circuit 20 to the LED 5. In one modified structure, a pulse width modulation driving circuit may be provided to have an internal constant current circuit and to function independently of a constant current driving circuit. This modified structure uses a switch to change over the connection between the output of the pulse width modulation driving circuit and the output of the constant current driving circuit.

(5) The light emitting element driver 10 of the embodiment independently changes over the drive mode based on the forward voltage with regard to each of the multiple LEDs used in the image display device. One possible modification may select one LED having the highest forward voltage among the multiple LEDs and change over the drive mode based on the highest forward voltage with regard to all the LEDs.

(6) In the embodiment described above, the LEDs are used as the light emitting elements. The light emitting elements are, however, not restricted to the LEDs but may be laser diodes or organic electroluminescence (EL) elements.

(7) In the embodiment described above, the LEDs as the light emitting elements are used for the image display device, such as a projector. The image display device is, however, not restrictive, but the LEDs may be used for any lighting equipment.

In accordance with other aspects of the invention, the light emitting element driver of the first aspect of the invention may have any of various configurations and arrangements described below.

In one preferable embodiment of the light emitting element driver, the pulse width modulation driving circuit is provided on a pathway of the current signal from the constant current driving circuit to the light emitting element and performs pulse width modulation of the current signal output from the constant current driving circuit. The high luminance controller outputs a pulse width specification signal for specifying a duty ratio of 100% to the pulse width modulation driving circuit to change over the driving signal supplied to the light emitting element.

In the high luminance area, the light emitting element driver of this embodiment disables the pulse width modulation function of the pulse width modulation driving circuit and enables the function of the constant current driving circuit to drive the light emitting element. In the low luminance area, the pulse width modulation driving circuit inputs the current signal from the constant current driving circuit. This arrangement does not require any additional power source for the pulse width modulation driving circuit and thus desirably simplifies the structure of the light emitting element driver.

In another preferable embodiment of the light emitting element driver of the first aspect of the invention, the low luminance controller outputs a current value specification signal, which specifies a current value corresponding to a minimum luminance in an allowable luminance control range by the high luminance controller, to the constant current driving circuit.

In the light emitting element driver of this embodiment, the pulse width modulation drive control by the pulse width modulation driving circuit uses the current signal having a current value of the highest power efficiency in the allowable luminance control range by the constant current driving circuit. This arrangement desirably improves the power efficiency in the low luminance area.

In another preferable embodiment of the light emitting element driver of the first aspect of the invention, the luminance detector determines whether the target luminance is lower than a preset reference luminance based on a forward voltage of the light emitting element and identifies the target luminance in the low luminance area upon determination of lower than the preset reference luminance while identifying the target luminance in the high luminance area upon determination of not lower than the preset reference luminance.

This arrangement enables the luminance adjustment even in the low luminance area of lower than the forward voltage.

The light emitting element as the object of the light emitting element driver may be a light emitting diode.

The embodiment and its modifications discussed above are to be considered in all aspects as illustrative and not restrictive. There may be many other modifications, changes, and alterations without departing from the scope or spirit of the main characteristics of the present invention. The scope and spirit of the present invention are indicated by the appended claims, rather than by the foregoing description.

What is claimed is:

1. A light emitting element driver that adjusts luminance of a light emitting element to a target luminance, the light emitting element driver comprising:
a constant current driving circuit that receives a current value specification signal and supplies a current signal having a current value specified by the current value specification signal as a driving signal to the light emitting element;
a pulse width modulation driving circuit that receives a pulse width specification signal for specifying a duty ratio of a pulse and supplies a current signal having a pulse width modulated by the pulse width specification signal as a driving signal to the light emitting element;
a luminance detector that identifies whether the target luminance is in a low luminance area or in a high luminance area;
a high luminance controller that, upon identification of the target luminance in the high luminance area by the luminance detector, outputs a current value specification signal corresponding to the target luminance to the constant current driving circuit and changes over the driving signal supplied to the light emitting element to an output of the constant current driving circuit; and
a low luminance controller that, upon identification of the target luminance in the low luminance area by the luminance detector, outputs a pulse width specification signal corresponding to the target luminance to the pulse width modulation driving circuit and changes over the driving signal supplied to the light emitting element to an output of the pulse width modulation driving circuit.

2. The light emitting element driver in accordance with claim 1, wherein the pulse width modulation driving circuit is provided on a pathway of the current signal from the constant current driving circuit to the light emitting element and performs pulse width modulation of the current signal output from the constant current driving circuit, and
the high luminance controller outputs a pulse width specification signal for specifying a duty ratio of 100% to the pulse width modulation driving circuit to change over the driving signal supplied to the light emitting element.

3. The light emitting element driver in accordance with claim 2, wherein the low luminance controller outputs a current value specification signal, which specifies a current value corresponding to a minimum luminance in an allowable luminance control range by the high luminance controller, to the constant current driving circuit.

4. The light emitting element driver in accordance with claim 1, wherein the luminance detector determines whether the target luminance is lower than a preset reference luminance based on a forward voltage of the light emitting element and identifies the target luminance in the low luminance area upon determination of lower than the preset reference luminance while identifying the target luminance in the high luminance area upon determination of not lower than the preset reference luminance.

5. The light emitting element driver in accordance with claim 1, wherein the light emitting element is a light emitting diode.

6. A light emitting element driving method that adjusts luminance of a light emitting element to a target luminance, the light emitting element driving method comprising:
(a) identifying whether the target luminance is in a low luminance area or in a high luminance area;
(b) upon identification of the target luminance in the high luminance area, supplying a current signal having a current value corresponding to the target luminance as a driving signal to the light emitting element; and
(c) upon identification of the target luminance in the low luminance area, supplying a current signal having a pulse width modulated corresponding to the target luminance as a driving signal to the light emitting element.

7. The light emitting element driving method in accordance with claim 6, wherein the step (c) modulates the pulse width of the current signal having a current value corresponding to a minimum luminance in an allowable luminance control range in the step (b).

8. The light emitting element driving method in accordance with claim 6, wherein the step (a) determines whether the target luminance is lower than a preset reference luminance based on a forward voltage of the light emitting element and identifies the target luminance in the low luminance area upon determination of lower than the preset reference luminance while identifying the target luminance in the high luminance area upon determination of not lower than the preset reference luminance.

9. The light emitting element driving method in accordance with claim 6, wherein the light emitting element is a light emitting diode.
